(19) United States
(12) Patent Application Publication
(10) Pub. No.: US 2012/0284271 A1
(43) Pub. Date: Nov. 8, 2012

(54) REQUIREMENT EXTRACTION SYSTEM, REQUIREMENT EXTRACTION METHOD AND REQUIREMENT EXTRACTION PROGRAM

(75) Inventor: Yukiko Kuroiwa, Tokyo (JP)

(73) Assignee: NEC CORPORATION, Tokyo (JP)

(21) Appl. No.: 13/522,656

(22) PCT Filed: Dec. 13, 2010
(86) PCT No.: PCT/JP2010/007229

§ 371 Date: Jul. 17, 2012

(30) Foreign Application Priority Data
Jan. 18, 2010 (JP) 2010-008010

(51) Int. Cl. G06F 17/30

(52) U.S. Cl. 707/737; 707/E17.089

(57) ABSTRACT

Included are a candidate extraction unit 61 that extracts, from a document formed by a group of character strings, a longest consecutive partial string common to one character string and the other character string as a candidate for an important word related to the one character string; a candidate integration unit 62 that selects a longest partial string of the candidate for the important word related to the one character string and extracted by the candidate extraction unit 61; and a group integration unit 63 that integrates a group of the longest partial string of each character string selected by the candidate integration unit 62, this group not forming a subset of a group of the other character string, thereby forming a group of the important word.

### TECHNICAL FIELD

The present invention relates to extraction of important words in a document, and in particular, to a requirement extraction system, a requirement extraction method, and a requirement extraction program, which extracts important words from a document that a client has, investigation results of interview questionnaire, meeting minutes, specifications or other related documents in developing software of a system.

### BACKGROUND ART

At the time of acquiring requirements, important words are extracted from a document that a client has, investigation results of interview questionnaire, meeting minutes, specifications or other related documents, so that the requirements of the client can be extracted without omission to reliably reflect them to specifications and design. The term “acquiring requirements” described above represents acquiring, from the client, conditions and performances which developing system has to satisfy to solve problems or achieve goals in development of software in the system. Conventionally, analyzers manually extract the important words in acquiring the requirements. However, it requires lots of efforts and time to extract the important words from the vast amount of documents, and there is a possibility that the important parts are overlooked due to human mistakes.

There is a method of extracting nouns and verbs employing morphological analysis to support the analyzer who extracts the important words at the time of acquiring the requirements. Non-patent Document 1 describes a requirements acquirement method of extracting the nouns and verbs.

Further, Patent Document 1 describes a requirements acquirement assistance device in which a Japanese text is parsed and divided into words to retrieve detailed patterns.

There is a method in which a partial string that appears plural times is extracted from a related document as an important word without dividing a text in advance on a word-by-word basis. Non-patent Document 2 describes a phrase find method in which a phrase that repeatedly appears is extracted as an important phrase.

### RELATED DOCUMENT

### Patent Document

Patent Document 1: Japanese Patent Application Laid-open No. 6-67862 (paragraphs [0013] to [0015])

### Non-Patent Document

Non-patent Document 1: “Extracting conceptual graphs from Japanese documents for software requirements modeling,” written by Ryo Hasegawa, Motohiro Kitamura, Haruhiko Kaiya, Motoshi Saeki, pp. 87-96 in a preprint of an international conference “Proceedings of the sixth Asia-pacific conference on conceptual modeling” (APCCM 2009) issued in 2009
Non-patent Document 2: “The use of a repeated phrase finder in requirements extraction,” written by Aguilera C., Berry D. M., pp. 209-230, volume 13, “Journal of Systems and Software” issued in 1990

### SUMMARY OF THE INVENTION

However, with the method of dividing the text on the word-by-word basis in advance as described in Non-patent Document 1 and Patent Document 1, there is a problem that important words cannot be correctly extracted due to an error in dividing words such as dividing a Japanese term “ [symbol] (right of foreigner to vote in elections)” into “ [symbol] (foreign),” “ [symbol] (-er to vote in),” “ [symbol] (right in elections).” Further, the method has a problem that it cannot treat unknown words that are not included in a dictionary used in the morphological analysis, so that such unknown words cannot be extracted as the important words. Thus, the method cannot extract abbreviation such as a group of English letters “ABC” as the important word.

With the method of extracting a partial string that appears plural times from the related document as described in Non-patent Document 2, a large number of similar words are extracted. This forces the analyzer to pay attention to overlapped portions at the time of determining the extraction words, leading to the large amount of efforts and time. Further, in the case of extracting a partial string without dividing on the word-by-word basis, the partial string may contain an inappropriate character such as “,” as the first character or final character in the word.

In view of the circumstances described above, an object of the present invention is to provide a requirements extraction technique in which an important word is extracted from a document without forcing an analyzer to make efforts and take plenty of time in acquiring requirements.

A requirement extraction system according to the present invention includes: a candidate extraction unit that extracts, from a document formed by a group of character strings, a longest consecutive partial string common to one character string and the other character string as a candidate for an important word related to the one character string; a candidate integration unit that selects a longest partial string of the candidate for the important word related to the one character string and extracted by the candidate extraction unit; and a group integration unit that integrates a group of the longest partial string of each character string selected by the candidate integration unit, this group not forming a subset of a group of the other character string, thereby forming a group of the important word.

A requirement extraction method according to the present invention includes: extracting, from a document formed by a group of character strings, a longest consecutive partial string common to one character string and the other character string as a candidate for an important word related to the one character string; selecting a longest partial string of the extracted candidate for the important word related to the one character string; and integrating a group of the selected longest partial string of each character string, this group not forming a subset of a group of the other character string, thereby forming a group of the important word.

A requirement extraction program according to the present invention, the program being for causing a computer to execute a process of: extracting, from a document formed by a group of character strings, a longest consecutive partial string common to one character string and the other character string as a candidate for an important word related to the one character string; selecting a longest partial string of the extracted candidate for the important word related to the one character string; and integrating a group of the selected longest partial string of each character string, this group not forming a subset of a group of the other character string, thereby forming a group of the important word.

According to the present invention, it is possible to extract an important word from a document without forcing an analyzer to make efforts and take plenty of time.

### BRIEF DESCRIPTION OF THE DRAWINGS

The above-described object and other objects of the present invention, and features and advantages of the present invention will be made further clear by the preferred exemplary embodiments described below and the following drawings attached thereto.

FIG. 1 is a block diagram illustrating an example of a configuration of a first exemplary embodiment of a requirement extraction system according to the present invention.

FIG. 2 is a flowchart showing an example of processes performed by the requirement extraction system illustrated in FIG. 1.

FIG. 3 is a block diagram illustrating an example of a configuration of a second exemplary embodiment of the requirement extraction system according to the present invention.

FIG. 4 is a flowchart showing an example of processes performed by an unnecessary word deleting unit of the requirement extraction system illustrated in FIG. 3.

FIG. 5 is a flowchart showing an example of processes performed by a candidate extraction unit of the requirement extraction system illustrated in FIG. 3.

FIG. 6 is a block diagram illustrating a main portion of the requirement extraction system according to the present invention.

### DESCRIPTION OF EMBODIMENTS

### Exemplary Embodiment 1

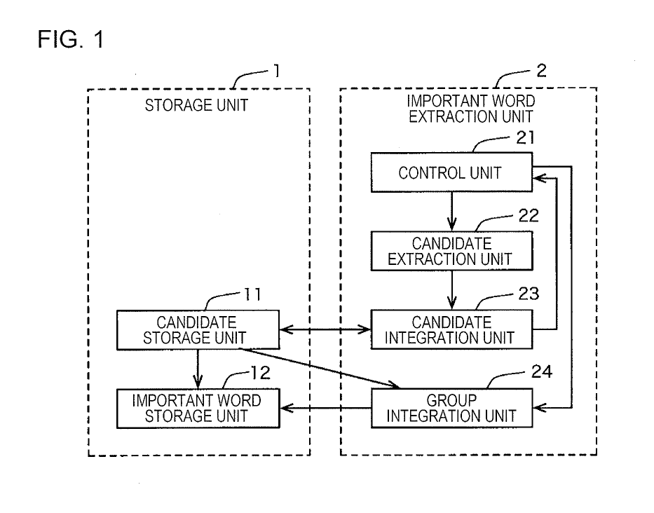

FIG. 1 is a block diagram illustrating an example of a configuration of a first exemplary embodiment (Exemplary Embodiment 1) of a requirement extraction system according to the present invention. The requirement extraction system illustrated in FIG. 1 includes a storage unit 1 and an important word extraction unit 2.

The term “document” represents a document that a client has, investigation results of interview questionnaire, meeting minutes, specifications or other documents related to developing software of a system. The term “character string” represents an element obtained by dividing the document on a meaning basis.

For example, in the case of a document having one item in one line, each of the lines is referred to as a character string. In the case where an answer made by one person is considered to have one meaning in questionnaire investigation results, plural sentences constituting the answer made by the person may be referred to as a character string. In the case where a document has one or more paragraphs each having one or more sets, at least one sentence constituting the paragraph may be referred to as a character string. In the case where a document has one or more chapters each having one or more sets, at least one sentence constituting the chapter may be referred to as a character string. In the case where a document has both a meaning unit delimited by a comma as a sentence and a meaning unit delimited by line, each of the sentence and the line may be referred to as a character string.

Further, in the case of simultaneously analyzing plural documents such as the first edition and the second edition, such plural documents are collectively referred to as a document. In the case where plural documents exist in different forms such as meeting minutes and specifications, such plural documents may be collectively referred to as a document.

The storage unit 1 includes a candidate storage unit 11 and an important word storage unit 12. The candidate storage unit 11 stores a group (candidate group) of candidates for the important word each related to each character string. The important word storage unit 12 stores a group (important word group) of important words each related to a document.

The important word extraction unit 2 includes a control unit 21, a candidate extraction unit 22, a candidate integration unit 23, and a group integration unit 24. The control unit 21, the candidate extraction unit 22, the candidate integration unit 23, and the group integration unit 24 are realized, for example, by a central processing unit (CPU) that performs processes in accordance with a program.

The control unit 21 controls, for example, a character string number allocated to a character string from which a candidate for an important word is extracted, and a starting position of a candidate word for the important word. The control unit 21 controls, for example, the character string number and the starting position so as to repeat an operation made by the candidate extraction unit 22 and an operation made by the candidate integration unit 23 for all the character strings in the document.

For each character string, the candidate extraction unit 22 extracts, as the candidate for the important word, one longest partial string of consecutive partial strings common to other character strings on the basis of the character string number controlled by the control unit 21, and the like.

The candidate integration unit 23 compares one candidate for the important word extracted by the candidate extraction unit 22 with the candidate group extracted in advance by the candidate extraction unit 22 and stored in the candidate storage unit 11. The candidate integration unit 23 selects the longest partial string of the candidates for the important word related to one character string. The candidate integration unit 23 adds the selected candidate for the important word to the candidate group, and stores it to the candidate storage unit 11.

The group integration unit 24 deletes a candidate group related to one character string and forming a subset of a candidate group related to the other character string. The group integration unit 24 integrates candidate groups related to each character string and not forming the subset of the candidate group related to the other character string, thereby forming an important word group. The group integration unit 24 stores the important word group to the important word storage unit 12.

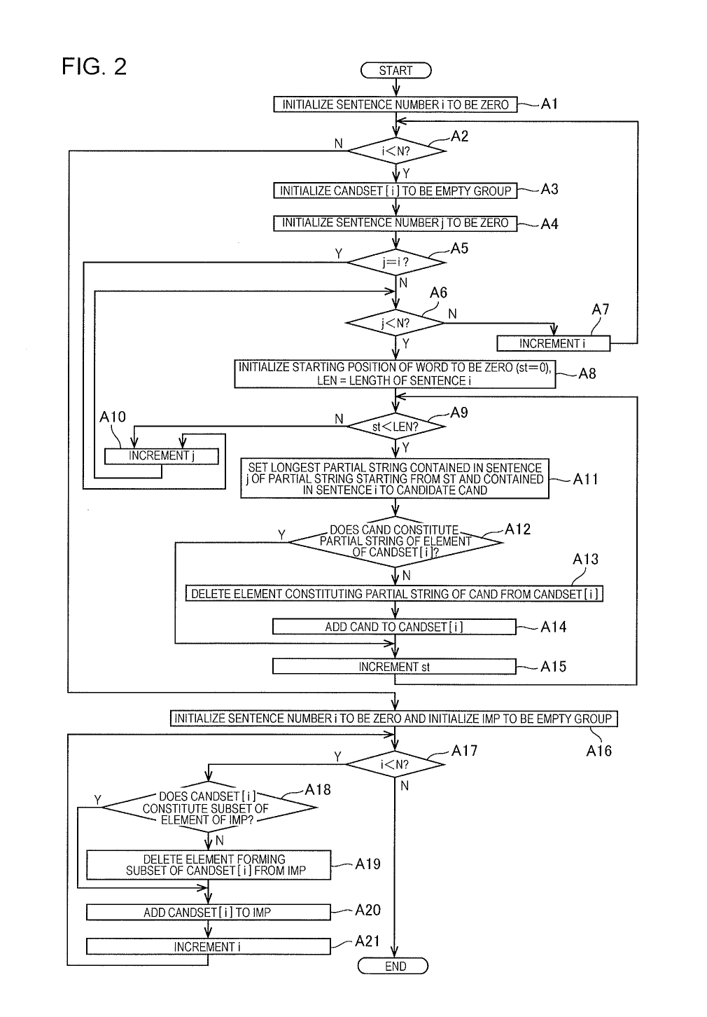

FIG. 2 is a flowchart illustrating an example of processes performed by the requirement extraction system illustrated in FIG. 1. With reference to FIG. 2, a description will be made of an operation of the requirement extraction system illustrated in FIG. 1 that extracts the important word from an document inputted, for example, through an input unit. Note that it is assumed as one example that each sentence constituting the inputted document is set as the character string. Further, the number of sentences constituting the inputted document is set to N.

In the example of the processes illustrated in FIG. 2, the control unit 21 controls a sentence number as the character string number. The sentence number represents a number allocated to each of the sentences in the document. For each sentence in the document, N integer numbers from zero to N−1 are allocated sequentially from the first sentence as the sentence number. First, the control unit 21 initializes a sentence number i to be zero (step A1).

Next, the control unit 21 compares the sentence number i with N (step A2). If the sentence number i is less than N (Y in step A2), the control unit 21 initializes the candidate group CANDSET [i] corresponding to the sentence number i to be an empty group (step A3). The candidate group CANDSET [i] is stored in the candidate storage unit 11. If the sentence number i is more than or equal to N (N in step A2), the flow proceeds to step A16.

Next, the control unit 21 initializes the sentence number j to be zero (step A4). Then, the control unit 21 compares the sentence number i with the sentence number j (step A5). If the sentence number i is equal to the sentence number j (Y in step A5), the flow proceeds to step A10. If the sentence number i is not equal to the sentence number j (N in step A5), the control unit 21 compares the sentence number j with N (step A6).

If the sentence number j is more than or equal to N (N in step A6), the control unit 21 increases the sentence number i by 1 (step A7), and the flow returns to step A2. Note that a process of increasing a value by 1 as in the process in step A7 is referred to as “increment.”

If the sentence number j is less than N (Y in step A6), the control unit 21 initializes the starting position (ST) of the word to be zero. The number of characters (length of the sentence i) constituting the sentence indicated by the sentence number i is referred to as LEN (step A8). Then, the control unit 21 compares the starting position ST of the word with the length LEN of the sentence i (step A9).

If the ST is more than or equal to LEN (N in step A9), the control unit 21 increments the sentence number j (step A10), and the flow returns to step A6.

If the ST is less than LEN (Y in step A9), the candidate extraction unit 22 examines a partial string starting from the starting position ST in each word contained in the sentence (sentence i) identified by the sentence number i, and extracts the longest partial string contained in a sentence (sentence j) identified by the sentence number j to set the extracted partial string to a candidate CAND (step A11).

Next, a detailed description will be made of the longest partial string extracted as a candidate CAND by the candidate extraction unit 22.

A sentence is deemed to be a character string having characters arranged therein. For example, in the case where a group A has α pieces of characters and is indicated by A={a_0, a_1, . . . , a_(a−1)}, a_i, which is an element of the group A, corresponds to one character selected from among a hiragana character, a katakana character, and a kanji character. In the case where A* is a group of character strings each having a finite length in A, each of the elements of the group A* corresponds to a word or a sentence.

A partial string S (ST, len) in the character string S represents a character string starting from a st^{th} character in the character string S and formed by a series of len pieces of characters. For example, in the case where the character string S is a character string of “ [symbol] [symbol] (candidate extraction unit)” (S=“ [symbol] (candidate extraction unit)”), the partial string includes S(0, 1)=“ [symbol] ,” S(0, 2)=“ [symbol] ,” and S(2, 2)=“ [symbol] .”

The recitation “character string CAND is the longest partial string with respect to the character string S and the character string T” means that: there exist st1, st2 and len that satisfy a relationship indicated by CAND=S(st1, len)=T(st2, len); and for a given character a included in the group A, the character string {CAND·a} is neither the partial string of character string S nor the partial string of the character string T, and further, the character string {a·CAND} is neither the partial string of the character string S nor the partial string of the character string T.

For example, it is assumed that a character string is a sentence, the sentence S is “ [symbol] [symbol] (extract an important word.),” and the sentence T is “ [symbol] [symbol] [symbol] ₒ (an important word represents a common partial string).” In this case, the longest partial string CAND with respect to the sentence S and the sentence T is “ [symbol] [symbol] (important word).” In the case where the CAND is set to “ [symbol] (important),” a character “ [symbol] (word)” exists as a character a constituting the character string {CAND·a} which is a partial string common to the sentence S and the sentence T. Thus, the word “ [symbol] (important)” is not the longest partial string with respect to the sentence S and the sentence T.

In the case where there exists no partial string common to both of the character strings that are targets for extraction, the candidate extraction unit 22 sets the candidate CAND to be an empty string. The term “empty string” represents a string “ ” that contains zero character. For example, in the case where a character of the starting position ST of a word in the sentence i is “α,” and the “α” is not contained in the sentence j, the candidate extraction unit 22 sets the candidate CAND to be an empty string=“ ”.

It should be noted that, for the candidate CAND extracted in step A11, the minimum character number MINLEN of the candidate CAND may be set in advance. The minimum character number MINLEN may be inputted by a user (analyzer) of the requirement extraction system through a keyboard or other input unit. Alternatively, the minimum character number MINLEN may be set by other manners. For example, in the case where the minimum character number MINLEN is set to “2” in advance, the candidate extraction unit 22 extracts, as the candidate CAND, the longest partial string from the partial strings having two or more characters and contained in both of the character strings that are targets for extraction. With the requirement extraction system having the minimum character number set in advance, the candidate for the important word having excessively short length is not extracted. This makes it possible to avoid presenting the important word having the excessively short length to the analyzer.

In step A11, once the candidate extraction unit 22 extracts the candidate CAND, the candidate integration unit 23 determines whether the candidate CAND is a partial string of an element constituting the candidate group CANDSET [i] (step A12).

A partial string having a length of LEN in the string S represents a string constituting a consecutive portion in the string S. The empty string represents a partial string having a length of zero in the string S. The string S represents a partial string having a length of LEN in the string S. For example, it is assumed that the candidate group CANDSET [i] is set to {“ [symbol] (control unit)”, “ [symbol] (candidate extraction)”}. In the case where a CAND is “ [symbol] (candidate),” the CAND forms a partial string of the element “ [symbol] (candidate extraction)” in the CANDSET [i]. In the case where the CAND is “ [symbol] (candidate extraction),” the CAND forms a partial string of the element “ [symbol] (candidate extraction)” in the CANDSET [i]. However, in the case where the CAND is “ [symbol] [symbol] (candidate extraction unit),” the CAND does not form a partial string of the element in the candidate group CANDSET [i].

If the candidate CAND does not form a partial string of the element in the candidate group CANDSET [i] (N in step A12), the candidate integration unit 23 deletes, from the CANDSET [i], the element corresponding to the partial string of the CAND from among the elements of the CANDSET [i] (step A13). For example, it is assumed that the candidate group CANDSET [i] is set to {“ [symbol] (control unit)”, “ [symbol] (candidate extraction)”}. In the case where the CAND is “ [symbol] (candidate extraction unit),” the element “ [symbol] (candidate extraction)” of the candidate group is a partial string of the CAND. Thus, the candidate integration unit 23 deletes the element “ [symbol] [symbol] (candidate extraction)” from the CANDSET [i] to form the candidate group CANDSET [i] to be {“ [symbol] (control unit)”}.

Next, the candidate integration unit 23 adds the candidate CAND to the candidate group CANDSET [i] (step A14). For example, it is assumed that the candidate group CANDSET [i] is set to {“ [symbol] (control unit)”}. In the case where the CAND is “ [symbol] (candidate extraction unit),” the candidate integration unit 23 adds the CAND to the CANDSET [i] to form CANDSET [i]={“ [symbol] (control unit)”, “ [symbol] (candidate extraction unit”}.

In the case where the candidate CAND forms a partial string of the element of the candidate group CANDSET [i] (Y in step A12), or a process described in step A14 is performed, the control unit 21 increments the starting position ST of the word (step A15). Then, the control unit 21 returns to step A9.

The control unit 21, the candidate extraction unit 22, and the candidate integration unit 23 repeat the processes described in step A1 to step A15 to extract the candidate group CANDSET [i] for all the sentences constituting the document. The extracted candidate group CANDSET [i] is stored in the candidate storage unit 11.

For all the sentences, once the candidate group CANDSET [i] is extracted, the group integration unit 24 initializes the sentence number i to be zero, and initializes the important word group IMP to be the empty group (step A16). The important word group IMP is a group of candidates for the important word stored in the important word storage unit 12.

The group integration unit 24 compares the sentence number i with N (step A17). If the sentence number i is more than or equal to N (N in step A17), the group integration unit 24 terminates its operation.

If the sentence number i is less than N (Y in step A17), the group integration unit 24 determines whether the candidate group CANDSET [i] for the sentence number i forms a subset of elements of the important word group IMP (step A18).

For example, it is assumed that the IMP is set to {{“ [symbol] (control unit)”, “ [symbol] (candidate extraction unit)”, “ [symbol] (candidate integration unit)”}, {“step”, “ [symbol] (sentence number)”}}. In the case where the CANDSET [i] is {“ [symbol] (control unit)”, “ [symbol] (candidate extraction unit)”}, the CANDSET [i] forms a subset of the first element of the IMP. In the case where the CANDSET [i] is {“ [symbol] (control unit)”, “ [symbol] (candidate extraction unit)”, “ [symbol] (candidate integration unit)”}, the CANDSET [i] also forms the subset of the first element of the IMP. However, in the case where the CANDSET [i] is {“ [symbol] (control unit)”, “ [symbol] (candidate extraction unit)”, “ [symbol] (candidate integration unit)”, “ [symbol] (group integration unit)”}, the CANDSET [i] does not form any subset of the element of the IMP.

If the candidate group CANDSET [i] of the sentence number i does not form the subset of the element of the important word group IMP (N in step A18), the group integration unit 24 deletes, from the IMP, an element constituting the subset of the CANDSET [i] of the elements of the IMP (step A19). For example, it is assumed that the IMP is set to {{“ [symbol] (control unit)”, “ [symbol] (candidate extraction unit)”, “ [symbol] (candidate integration unit)”}, {“step”, “ [symbol] (sentence number)”}}. In the case where the CANDSET [i] is {“ [symbol] (control unit)”, “ [symbol] (candidate extraction unit)”, “ [symbol] (candidate integration unit)”, “ [symbol] (group integration unit)”}, the first element {“ [symbol] (control unit)”, “ [symbol] [symbol] (candidate extraction unit)”, “ [symbol] (candidate integration unit)”} of the IMP forms a subset of the CANDSET [i]. Thus, the group integration unit 24 deletes the first element from the IMP to obtain IMP={{“step”, “ [symbol] (sentence number)”}}.

Next, the group integration unit 24 adds a candidate group CANDSET [i] to the important word group IMP (step A20). For example, it is assumed that the IMP is set to {{“step”, “ [symbol] (sentence number)”}}. In the case where the CANDSET [i] is {“ [symbol] (control unit)”, “ [symbol] (candidate extraction unit)”, “ [symbol] (candidate integration unit)”, “ [symbol] (group integration unit)”}, the group integration unit 24 adds this CANDSET [i] to the IMP to obtain the IMP={{“ [symbol] (control unit)”, “ [symbol] (candidate extraction unit)”, “{ [symbol] (candidate integration unit)”, “ [symbol] (group integration unit)”}, {“step”, “ [symbol] (sentence number)”}}. The group integration unit 24 may store this IMP, which has the CANDSET [i] added thereto, to the important word storage unit 12.

If the candidate group CANDSET [i] of the sentence number i forms a subset of the element of the important word group IMP (Y in step A18), or the process described in step A20 is performed, the group integration unit 24 increments the sentence number i (step A21). Then, the group integration unit 24 returns to step A17.

It should be noted that the control unit 21 may output the important word stored in the important word storage unit 12 to a display, a printer or other output unit at the timing of terminating the operation.

The requirement extraction system of the first exemplary embodiment having the configuration as described above can extract the important words without previously dividing into words using the morphological analysis in a manner such that partially matching words are not extracted. Thus, it is possible to extract important words from the document in a more precise manner, as compared with the case using the morphological analysis with which errors possibly occur at the time of dividing into words.

Further, the requirement extraction system of the first exemplary embodiment only extracts, as the candidate for the important word, the longest partial string common to character strings that are targets for extraction. Thus, it is possible to avoid extracting a large number of similar words, and minimize the number of extracted important words, reducing the efforts and time of the analyzer to check the important words.

Further, the requirement extraction system of the first exemplary embodiment extracts the important words without using any dictionary. Thus, unlike the morphological analysis, which cannot handle the unknown words that are not registered in a dictionary, the requirement extraction system of the first exemplary embodiment can extract the important words from a document containing unknown words. Further, it can extract, as the important words, unknown words such as a coined word formed by combining existing words and an abbreviation formed by using a part of an existing word.

It should be noted that, since the large amount of documents are handled in obtaining the requirements, it is preferable to reduce the amount of memory used. In the requirement extraction system of the first exemplary embodiment, one character string is compared with the other character string to retrieve the candidate for the important word on the basis of the common and consecutive partial string, whereby it does not use a large amount of memory at one time, and it is possible to make a calculation with the small amount of memory used.

### Exemplary Embodiment 2

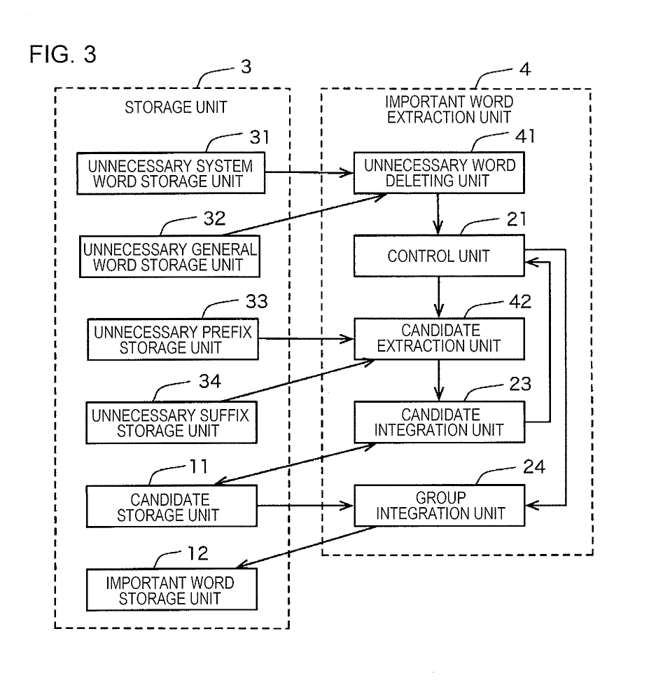

FIG. 3 is a block diagram illustrating an example of a configuration of a second exemplary embodiment (Exemplary Embodiment 2) of a requirement extraction system according to the present invention. The requirement extraction system illustrated in FIG. 3 has a storage unit 3 and an important word extraction unit 4.

The storage unit 3 includes an unnecessary system word storage unit 31, an unnecessary general word storage unit 32, an unnecessary prefix storage unit 33, an unnecessary suffix storage unit 34, the candidate storage unit 11, and the important word storage unit 12. The candidate storage unit 11 and the important word storage unit 12 illustrated in FIG. 3 are storage units equivalent to the candidate storage unit 11 and the important word storage unit 12 illustrated in FIG. 1.

The unnecessary system word storage unit 31 stores unnecessary system words in advance. The term “unnecessary system word” represents a word related to a system development such as a name of a company and determined, for each document, to be not necessary to be extracted as the important word.

The unnecessary general word storage unit 32 stores unnecessary general words in advance. The term “unnecessary general word” represents a word determined to be generally not necessary to be extracted as the important word. For example, the terms “ [symbol] (the following)” and “ [symbol] (the above-described)” are words determined to be generally not necessary to be extracted as the important word.

The unnecessary prefix storage unit 33 stores unnecessary prefixes in advance. The term “unnecessary prefix” represents a character inappropriate for the first letter of a word such as “ [symbol] (ₐ),” “, (comma),” “∘ (period),” and “(blank space).”

The unnecessary suffix storage unit 34 stores unnecessary suffixes in advance. The term “unnecessary suffix” represents a character inappropriate for the last letter of a word such as “ [symbol] (-like),” “, (comma),” “∘ (period),” and “(blank space).”

It should be noted that these unnecessary words or characters such as the unnecessary system word, the unnecessary general word, the unnecessary prefix, and the unnecessary suffix may be inputted in advance by the user (analyzer) of the requirement extraction system through an input unit such as a keyboard, or may be inputted in the other manner.

The important word extraction unit 4 includes an unnecessary word deleting unit 41, a control unit 21, a candidate extraction unit 42, a candidate integration unit 23, and a group integration unit 24. The control unit 21, the candidate integration unit 23, and the group integration unit 24 illustrated in FIG. 3 operate in an equivalent manner to the control unit 21, the candidate integration unit 23, and the group integration unit 24 illustrated in FIG. 1. The unnecessary word deleting unit 41, the control unit 21, the candidate extraction unit 42, the candidate integration unit 23, and the group integration unit 24 are realized, for example, by the CPU that performs processes in accordance with a program.

The unnecessary word deleting unit 41 deletes, from the entire document, all the unnecessary system words stored in advance in the unnecessary system word storage unit 31, and then, deletes, from the entire document, all the unnecessary general words stored in advance in the unnecessary general word storage unit 32. It should be noted that, rather than deleting the unnecessary system words and the unnecessary general words in the document, the unnecessary word deleting unit 41 may replace them with blanks.

The candidate extraction unit 42 extracts, from the character string, a candidate for the important word whose first character (prefix) does not include any unnecessary prefix stored in the unnecessary prefix storage unit 33 and whose last character (suffix) does not include any unnecessary suffix stored in the unnecessary suffix storage unit 34, on the basis, for example, of the character string number controlled by the control unit 21.

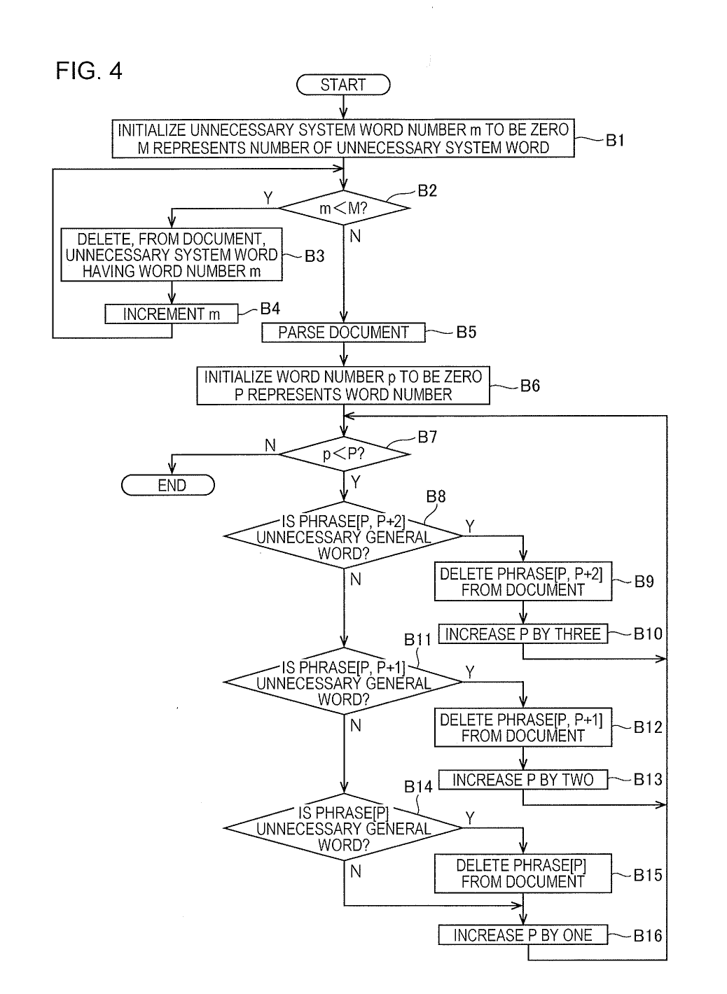

FIG. 4 is a flowchart illustrating an example of processes performed by the unnecessary word deleting unit of the requirement extraction system illustrated in FIG. 3. With reference to FIG. 4, a description will be made of how the unnecessary word deleting unit 41 illustrated in FIG. 3 deletes the unnecessary system word and the unnecessary general word inputted, for example, through an input unit.

First, the unnecessary word deleting unit 41 initializes the unnecessary system word number m to be zero. The character M represents the total number of the unnecessary system words stored in the unnecessary system word storage unit 31 (step B1). The unnecessary system word numbers are numbers allocated sequentially to the respective unnecessary system words stored in the unnecessary system word storage unit 31, and M integers from zero to M−1 are allocated to the respective unnecessary system words.

Next, the unnecessary word deleting unit 41 compares the unnecessary system word number m with M (step B2). If the unnecessary system word number m is less than M (Y in step B2), the unnecessary word deleting unit 41 deletes, from the document, all the unnecessary system words having the unnecessary system word number m (step B3). Then, the unnecessary word deleting unit 41 increments the m (step B4), and the flow returns to step B2. If the unnecessary system word number m is more than or equal to M (N in step B2), the flow proceeds to step B5.

Next, for morphemes obtained by dividing the document, the unnecessary word deleting unit 41 deletes the unnecessary general word stored in the unnecessary general word storage unit 32. FIG. 4 illustrates an example of a process of examining whether or not three or less consecutive morphemes match the unnecessary general word, while taking into consideration a case where the document is excessively finely divided into words as morphemes.

First, the unnecessary word deleting unit 41 parses the document, and divides the document into morphemes (step B5). Then, the unnecessary word deleting unit 41 initializes a word number p to be zero. Further, the total number of the divided morphemes is set to P (step B6). The word numbers are numbers each allocated sequentially to the respective divided morphemes, and P integers from zero to P−1 are allocated to the respected divided morphemes.

The unnecessary word deleting unit 41 compares the word number p with the P (step B7). If the word number p is P or more (N in step B7), the unnecessary word deleting unit 41 terminates the process.

In this specification, the morpheme identified by the word number p is referred to as a PHRASE [p]. Further, a PHRASE [p, p+1] represents a {PHRASE [p]·PHRASE [p+1]}. A PHRASE [p, p+2] represents a {PHRASE [p]·PHRASE [p+1]·PHRASE [p+2]}.

If the p is less than P (Y in step B7), the unnecessary word deleting unit 41 examines whether or not the PHRASE [p, p+2] matches any of the unnecessary general words stored in the unnecessary general word storage unit (step B8).

If the PHRASE [p, p+2] matches any of the unnecessary general words stored in the unnecessary general word storage unit 32 (Y in step B8), the unnecessary word deleting unit 41 deletes the PHRASE [p, p+2] from the document (step B9). Further, the word number p is increased by 3 (step B10), and the flow returns to step B7.

If the PHRASE [p, p+2] does not match any of the unnecessary general words stored in the unnecessary general word storage unit 32 (N in step B8), the unnecessary word deleting unit 41 examines whether the PHRASE [p, p+1] matches any of the unnecessary general words stored in the unnecessary general word storage unit (step B11).

If the PHRASE [p, p+1] matches any of the unnecessary general words stored in the unnecessary general word storage unit 32 (Y in step B11), the unnecessary word deleting unit 41 deletes the PHRASE [p, p+1] from the document (step B12). Then, the word number p is increased by 2 (step B13), and the flow returns to step B7.

If the PHRASE [p, p+1] does not match any of the unnecessary general words stored in the unnecessary general word storage unit 32 (N in step B11), the unnecessary word deleting unit 41 examines whether or not the PHRASE [p] matches any of the unnecessary general words stored in the unnecessary general word storage unit (step B14).

If the PHRASE [p] matches any of the unnecessary general words stored in the unnecessary general word storage unit 32 (Y step B14), the unnecessary word deleting unit 41 deletes the PHRASE [p] from the document (step B15). Then, the word number p is increased by 1 (step B16), and the flow returns to step B7.

If the PHRASE [p] does not match any of the unnecessary general words stored in the unnecessary general word storage unit 32 (N in step B14), the flow proceeds to step B16.

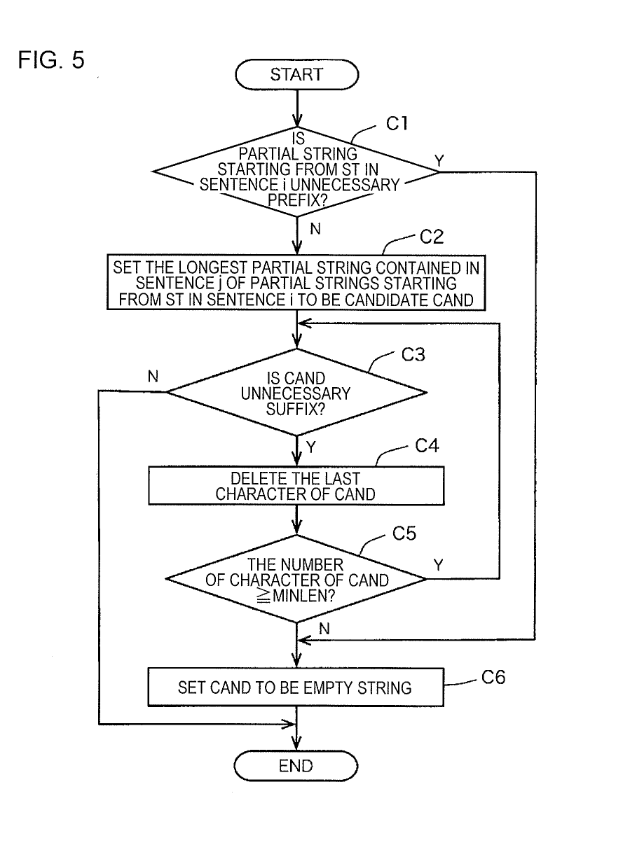

FIG. 5 is a flowchart illustrating an example of processes performed by a candidate extraction unit of the requirement extraction system illustrated in FIG. 3. With reference to FIG. 5, a description will be made of how the candidate extraction unit 42 illustrated in FIG. 3 extracts each candidate for the important word, for example, in the case where a sentence is used as the character string.

In this exemplary embodiment, MINLEN represents the minimum character number of the candidate for the important word. The minimum character number MINLEN may be inputted by the user (analyzer) of the requirement extraction system through a keyboard or other input unit, or may be inputted in the other manner. Further, the minimum character number MINLEN may be set, for example, to 1 or 2 in advance.

First, the candidate extraction unit 42 examines whether or not a partial string in a sentence i starting from a starting position ST matches any of the unnecessary prefixes stored in the unnecessary prefix storage unit 33 (step C1).

If the partial string in the sentence i starting from the starting position ST does not match any of the unnecessary prefixes stored in the unnecessary prefix storage unit 33 (N in step C1), the candidate extraction unit 42 extracts the longest partial string contained in the sentence j from among the partial strings in the sentence i starting from the starting position ST, and sets the extracted partial string to be a candidate CAND (step C2). If the partial string in the sentence i starting from the starting position ST matches any of the unnecessary prefixes (Y in step C1), the flow proceeds to step C6.

The candidate extraction unit 42 examines whether or not the candidate CAND matches any of the unnecessary suffixes stored in the unnecessary suffix storage unit 34 (step C3).

If the candidate CAND does not match any of the unnecessary suffix stored in the unnecessary suffix storage unit 34 (N in step C3), the candidate extraction unit 42 terminates the operation.

If the candidate CAND matches any of the unnecessary suffixes stored in the unnecessary suffix storage unit 34 (Y in step C3), the candidate extraction unit 42 deletes the last character of the candidate CAND (step C4). Then, the candidate extraction unit 42 compares the number of characters of the candidate CAND with the minimum character number MINLEN (step C5).

If the number of characters in the candidate CAND is more than or equal to the minimum character number MINLEN (N in step C5), the flow returns to step C3. The number of characters in the candidate CAND is less than the minimum character number MINLEN (N in step C5), the candidate extraction unit 42 sets the candidate CAND to be an empty string (step C6).

With the requirement extraction system according to the second exemplary embodiment and having the configuration described above, the unnecessary work deleting unit 41 examines, without parsing, whether or not there exists a portion that matches any of the unnecessary system words stored in the unnecessary system word storage unit 31 to delete the unnecessary system word from the entire document. Thus, even if the unnecessary system word is a coined word, an abbreviation or other unknown words that are not registered in a dictionary used in parsing, the requirement extraction system can delete these words.

Further, in the requirement extraction system of the second exemplary embodiment, the unnecessary word deleting unit 41 examines whether or not a word formed by plural morphemes obtained by dividing through parsing is the unnecessary general word, and deletes the word. Thus, it is possible to reliably delete the unnecessary general word even in the case where the morphemes are excessively finely divided through parsing.

Further, in the requirement extraction system of the second exemplary embodiment, the candidate extraction unit 42 deletes the unnecessary prefixes and the unnecessary suffixes from the candidates for the important word. Thus, it is possible to extract the important words in a desired form so as not to include the unnecessary prefixes and the unnecessary suffixes. For example, for the partial string starting with “, (comma),” a word having the first character “, (comma)” deleted therefrom is extracted, whereby it is expected that the important words can be extracted in a form that the analyzer can easily check.

Further, in the requirement extraction system of the second exemplary embodiment, the unnecessary words such as the unnecessary system words, the unnecessary general words, the unnecessary prefixes and the unnecessary suffix are deleted to extract the important words. Thus, it is possible to reduce the number of important words as compared with the extraction by the requirement extraction system of the first exemplary embodiment. Thus, with the requirement extraction system of the second exemplary embodiment, the efforts and time required for the analyzer to check the important words can be further reduced.

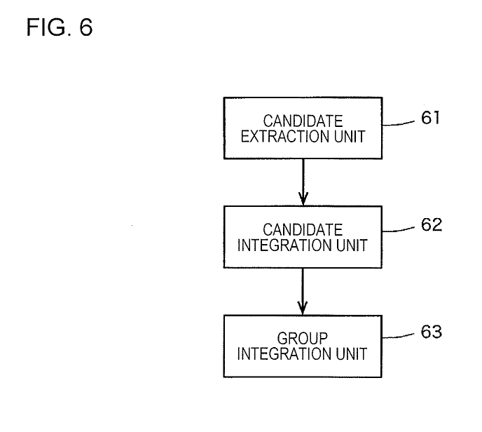

FIG. 6 is a block diagram illustrating a main portion of the requirement extraction system according to the present invention. As illustrated in FIG. 6, the requirement extraction system includes: a candidate extraction unit 61 (corresponding, for example, to the candidate extraction unit 22 illustrated in FIG. 1) that extracts, from a document which is formed by a group of character strings (for example, sentences), the longest partial string of all the consecutive partial strings common to one character string and the other character string, as a candidate (corresponding, for example, to the candidate CAND in the first exemplary embodiment) for the important word related to the one character string; a candidate integration unit 62 (corresponding, for example, to the candidate integration unit 23 illustrated in FIG. 1) that selects the longest partial string of the candidates for the important word related to the one character string extracted by the candidate extraction unit 61; and a group integration unit 63 (corresponding, for example, to the group integration unit 24 illustrated in FIG. 1) that integrates groups (corresponding, for example, to the candidate group CANDSET[i] in the first exemplary embodiment) of respective character strings formed by the candidates for the important word selected by the candidate integration unit 62, the integrated groups not forming a subset of the group related to the other character string, thereby forming a group of important words (corresponding, for example, to the important word group IMP in the first exemplary embodiment).

Further, the exemplary embodiments described above also disclose the requirement extraction systems as described in (1) to (5) below.

(1) A requirement extraction system in which the candidate extraction unit only extracts, as the candidate for the important word, a partial string having a predetermined character number (corresponding, for example, to the minimum character number MINLEN in the first exemplary embodiment) or more from the longest consecutive partial strings common to one character string and the other character string.

(2) A requirement extraction system having an unnecessary word deleting unit (corresponding, for example, to the unnecessary word deleting unit 41 illustrated in FIG. 3) that deletes, from the document, an unnecessary word determined in advance to be not necessary to be extracted as the important word.

(3) A requirement extraction system having an unnecessary word deleting unit that deletes (realized, for example, by the operations shown in Step B1 to Step B4 in FIG. 4), from the document, a portion matching the unnecessary word (corresponding, for example, to the unnecessary system word stored in the unnecessary system word storage unit 31 illustrated in FIG. 3) determined for each document in advance to be not necessary to be extracted. If one or more consecutive morphemes obtained by dividing through parsing matches the unnecessary word (corresponding, for example, to the unnecessary general word stored in the unnecessary general word storage unit 32 illustrated in FIG. 3) determined in advance to be generally not necessary to be extracted, the unnecessary word deleting unit deletes (realized, for example, by the operations shown in Step B5 to Step B16 in FIG. 4) the morphemes from the document.

(4) A requirement extraction system in which the candidate extraction unit extracts (realized, for example, by the operation shown in Step C1 to Step C6 in FIG. 5) a candidate for the important word whose first character does not include any unnecessary prefix (corresponding, for example, to the unnecessary prefix stored in the unnecessary prefix storage unit 33 illustrated in FIG. 3) determined in advance and inappropriate as the first character of the important word and whose last character does not include any unnecessary suffix (corresponding, for example, to the unnecessary suffix stored in the unnecessary suffix storage unit 34 illustrated in FIG. 3) determined in advance and inappropriate as the last character of the important word.

(5) A requirement extraction system in which the character string represents any of a sentence, a line, a paragraph and a chapter in a document, or a combination thereof.

(Supplementary Note (S.N.) 1) A requirement extraction method in which an unnecessary word determined in advance to be not necessary to be extracted as the important word is deleted from the document.

(S.N. 2) A requirement extraction method in which a portion matching an unnecessary word determined for each document in advance to be not necessary to be extracted is deleted from the document, and one or more consecutive morphemes divided through parsing are deleted from the document if the one or more morphemes match the unnecessary word determined in advance to be generally not necessary to be extracted.

(S.N. 3) A requirement extraction method of extracting a candidate for the important word whose first character does not include any unnecessary prefix determined in advance and inappropriate as the first character of the important word, and whose last character does not include any unnecessary suffix determined in advance and inappropriate as the last character of the important word.

(S.N. 4) A requirement extraction program for causing a computer to execute a process of deleting, from the document, an unnecessary word determined in advance to be not necessary to be extracted as the important word.

(S.N. 5) A requirement extraction program for causing a computer to execute a process of deleting, from a document, a portion matching an unnecessary word determined for each document in advance to be not necessary to be extracted, and deleting, from the document, one or more consecutive morphemes divided through parsing if the one or more morphemes match the unnecessary word determined in advance to be generally not necessary to be extracted.

(S.N. 6) A requirement extraction program for causing a computer to execute a process of extracting a candidate for the important word whose first character does not include any unnecessary prefix determined in advance and inappropriate as the first character of the important word, and whose last character does not include any unnecessary suffix determined in advance and inappropriate as the last character of the important word.

It should be noted that, in the descriptions in the exemplary embodiments above, plural flowcharts are used, and in each of the flowcharts, plural steps are specified in a sequential order. However, this specification of the order does not limit the order of the respective steps in the information processing method according to the present invention. Therefore, at the time of performing the information processing method according to the present invention, the order of the plural steps may be changed, provided that such a change does not impair the contents thereof.

It should be noted that, naturally, the above-described exemplary embodiments and plural modification examples can be combined, provided that contents thereof do not contradict each other. Further, in the above-described exemplary embodiments and modification examples thereof, functions of the constituting elements have been specifically described. These functions may be changed in various manners within the scope that satisfies the present invention.

The present application claims priority based on Japanese Patent Application No. 2010-8010 filed in Japan on Jan. 18, 2010, the disclosures of which are incorporated herein by reference in their entirety.

1. A requirement extraction system, comprising:
a candidate extraction unit that extracts, from a document formed by a group of character strings, a longest consecutive partial string common to each partial character string included in one character string and the other character string as a candidate for an important word related to the one character string;
a candidate integration unit that selects a group of a longest consecutive partial string of the candidate common to the one character string and the other character string by selecting a longest candidate from the candidates in inclusive relation in the candidates for the important word related to the one character string and extracted by the candidate extraction unit; and
a group integration unit that integrates a group of the longest partial string related to each character string and selected by the candidate integration unit, said group not forming a subset of a group of the other character string, thereby forming a group of the important word.

2. The requirement extraction system according to claim 1, wherein the candidate extraction unit extracts, as the candidate for the important word, a partial string having a predetermined character number or more from the longest consecutive partial string common to each partial character string included in the one character string and the other character string.

3. The requirement extraction system according to claim 1, further comprising:
an unnecessary word deleting unit that deletes, from the document, an unnecessary word determined in advance to be not necessary to be extracted as the important word.

4. The requirement extraction system according to claim 3, wherein the unnecessary word deleting unit deletes, from the document, a portion matching an unnecessary word determined for each document in advance to be not necessary to be extracted, and deletes, from the document, one or more consecutive morphemes divided through parsing if said one or more consecutive morphemes match the unnecessary word determined in advance to be generally not necessary to be extracted.

5. The requirement extraction system according to claim 1, wherein the candidate extraction unit extracts a candidate for the important word whose first character does not include any unnecessary prefix determined in advance and inappropriate as the first character of the important word and whose last character does not include any unnecessary suffix determined in advance and inappropriate as the last character of the important word.

6. The requirement extraction system according to claim 1, wherein the character string represents any of a sentence, a line, a paragraph and a chapter in the document, or a combination thereof.

7. A requirement extraction method, including:
extracting, from a document formed by a group of character strings, a longest consecutive partial string common to each partial character string included in one character string and the other character string as a candidate for an important word related to the one character string;
selecting a group of a longest consecutive partial string common to the one character string and the other character string by selecting a longest candidate from the candidates in inclusive relation in the extracted candidate for the important word related to the one character string; and
integrating a group of the selected longest partial string of each character string, said group not forming a subset of a group of the other character string, thereby forming a group of the important word.

8. The requirement extraction method according to claim 7, wherein the method only extracts, as the candidate for the important word, a partial string having a predetermined character number or more from the longest consecutive partial string common to each partial character string included in the one character string and the other character string.

9. A requirement extraction program for causing a computer to execute a process of:
extracting, from a document formed by a group of character strings, a longest consecutive partial string common to each partial character string included in one character string and the other character string as a candidate for an important word related to the one character string;
selecting a group of a longest consecutive partial string common to the one character string and the other character string by selecting a longest candidate from the candidates in inclusive relation in the extracted candidate for the important word related to the one character string; and
integrating a group of the selected longest partial string of each character string, said group not forming a subset of a group of the other character string, thereby forming a group of the important word.

10. The requirement extraction program according to claim 9, the program being for causing a computer to further execute a process of only extracting, as the candidate for the important word, a partial string having a predetermined character number or more from the longest consecutive partial string common to each partial character string included in the one character string and the other character string.
